(19) United States
(12) Patent Application Publication
(10) Pub. No.: US 2016/0048945 A1
(43) Pub. Date: Feb. 18, 2016

(54) Method and Apparatus of Generating Image

(71) Applicant: Hitachi, Ltd., Tokyo (JP)

(72) Inventors: Nobuhiro CHIHARA, Tokyo (JP); Takashi WATANABE, Tokyo (JP)

(21) Appl. No.: 14/817,902

(22) Filed: Aug. 4, 2015

(30) Foreign Application Priority Data
Aug. 5, 2014 (JP) 2014-159458

(51) Int. Cl. G06T 3/40; G06K 9/46; G06T 5/50; H04N 5/232

(52) U.S. Cl. CPC G06T 3/4038; H04N 5/23238; G06K 9/4604; G06T 5/50; G06T 2207/10016

(57) ABSTRACT

In a method of generating a mosaic image from consecutive images taken by a moving or rotating camera, to provide means for generating a highly fine mosaic image having little distortion at high speed, plural taken images consecutive in time series are inputted from a camera, a key image is set at an image pair selecting unit, necessary minimum image pairs for reducing distortion of a mosaic image are selected based on sensor information mounted on a camera at image taking time points stringed to the key image and the respective images, corresponding points in the respective image pairs are detected by a corresponding point searching unit, and positions of the respective images on the mosaic image are adjusted based on the corresponding points at an image position adjusting unit.

### CLAIM OF PRIORITY

The present application claims priority from Japanese application serial no. JP2014-159458, filed on Aug. 5, 2014, the content of which is hereby incorporated by reference into this application.

### BACKGROUND OF THE INVENTION

1. Field of the Invention

The present invention relates to a mosaic image generating method for generating a highly fine wide area image by pasting together plural images from plural sheets of time series image data taken by a moving or a rotating camera. The invention particularly relates to a method of generating a mosaic image at high speed.

2. Description of the Related Art

An explanation will be given of the background of the present invention.

In recent years, collection of information by an airplane has been utilized for collecting information at a disaster-stricken area, or for managing mines, agricultural areas, forestry areas or the like. Among the information collected by an airplane, information of an image taking the ground has particularly been utilized for various uses. Among them, a mosaic image which can be generated by connecting together plural taken images is effective for grasping a situation of a total of a photographed area since the total of the photographed area can command a bird's eye view.

Therefore, a technology of generating a wide area mosaic image which covers a wide area and has a high resolution by connecting together plural taken images taken by a camera mounted on an airplane becomes important. Incidentally, the use of the mosaic image generating technology is not limited to the airy taken image generation of a wide range but the technology can also be utilized for generating a panoramic image synthesizing scenery images, and its application range is wide.

Next, an explanation will be given of a general method of generating a mosaic image.

FIGS. 1A and 1B are views indicating a concept of a mosaic image generating processing.

In generating a mosaic image, first, as shown in FIG. 1A, a feature point is detected by utilizing an image feature of a corner feature or the like for an image taken by the camera. The feature point is present at a position surrounded by a dotted line 101 in FIG. 1A. Next, as shown in FIG. 1B, a correspondence 102 of feature points is carried out from information of respective feature points of two sheets of images between all of images taking the same area, and a pair of corresponding feature points are made to be corresponding points.

Here, an image may be a stationary image taken at prescribed time intervals, or may capture a prescribed frame from a continuously taken dynamic image.

Next, positions of respective images in a mosaic image are adjusted such that reprojection errors of corresponding points between respective images are minimized by using a technology referred to as a bundle adjusting method.

At this occasion, what is generally utilized as positions of respective images in a mosaic image is a nomography matrix representing a perspective projection conversion between planes, and when respective coordinates in an image n are respectively defined as [un vn], coordinates [u v] in a corresponding mosaic image can be represented by Equation 1.

$$[ \begin{matrix}u \\ v \\ 1\end{matrix} ] = {s}_{n} [ \begin{matrix}{a}_{n} & {b}_{n} & {c}_{n} \\ {d}_{n} & {e}_{n} & {f}_{n} \\ {g}_{n} & {h}_{n} & 1\end{matrix} ] [ \begin{matrix}{u}_{n} \\ {v}_{n} \\ 1\end{matrix} ] \qquad Equation 1$$

Further, in a case where positions of certain two images in a mosaic image are determined, as a reprojection error between respective images, a reprojection error of respective corresponding points between two images can be calculated by Equation 2 as follows.

E(p)=Σ∥(HₙPₙ−HₘPₘ)∥² Equation 2

In the bundle adjusting method, positions of respective images for minimizing a total sum of the reprojection error is calculated by using Levenberg-Marquardt method or the like. Finally, a mosaic image is generated by deforming and superposing respective images in accordance with a nomography matrix representing positions of respective images in a mosaic image calculated by the bundle adjusting method.

FIGS. 2A and 2B are views expressing a correction of an error of a mosaic image by the bundle adjusting method. In FIGS. 2A and 2B, photographing is carried out by going around to make a loop with an image 201a as a start point, and finally, the same area is photographed at an image 201b. Here, the loop refers to that an object (for example, road 202) included in the start point image 201a is not included in successive images, and the same object (for example, road 202) is included again in an image 201b.

In a case where the bundle adjustment is not used, large distortion is produced in the mosaic image such that images are not connected despite that the camera photographs the same area as shown in FIG. 2A and large distortion is produced in the mosaic image.

This is caused by that errors caused by mismatching of corresponding points between images or detection accuracies of feature points are accumulated, the more increased the number of sheets of images, the more increased the error, which finally brings about large distortion.

On the other hand, in a case where the bundle adjustment is used, as shown in FIG. 2B, positions of total images are adjusted such that images taking the same area are connected, and therefore, a mosaic image having little distortion is obtained.

However, the distortion can be corrected by the bundle adjustment in a case where the images are looped as shown in FIGS. 2A and 2B, and the error cannot be corrected in a case where the images do not make a loop.

Therefore, in generating the mosaic image, it is a very important requirement to be able to produce a loop of images in producing a mosaic image having little distortion.

As described above, in order to produce a mosaic image having little distortion, it is important to produce a loop in all the images.

In a case where a photographing area of images makes a loop, a bundle adjustment can be carried out by making a loop by calculating corresponding points between images among all the images, and determining that two images having a large number of corresponding points take an image of the same area.

However, when corresponding points are calculated among all the images, enormous time is taken for a corresponding point detecting process since a number of relevance between images is increased in proportion to a square of a number of sheets of images acquired.

This poses a problem also in an image analysis field which carries out bundle adjustment in other than generating a mosaic image such as a three-dimensional shape restoration. “Practical SfM system suitable for On-line Photography” Electronics, Information, and Communication Society, D Vol. J96-D No. 8 pp. 1753-1763 takes a measure such that a similarity of images is calculated beforehand among all of images, and a corresponding relationship is calculated only between similar images based on the similarity such that a corresponding relationship is not calculated between images taking different areas.

However, according to the method, in a case where images are similar to each other even at different areas, an erroneous image relationship is calculated. Also, in a case where all of taken image are similar to each other, as a result, there is a case where it is necessary to calculate corresponding relationships among a great number of images. Particularly, in generating a mosaic image taking image of the same area by plural times while moving a camera, such a problem is liable to be posed.

The present invention has been carried out in view of the problems described above, and intends to generate a mosaic image having little distortion by using bundle adjustment at high speed by calculating corresponding points only between images suitable for bundle adjustment from a large amount of taken images.

### SUMMARY OF THE INVENTION

FIG. 24 shows a conceptual view of the present invention. In the drawing, respective rectangles indicate plural taken images.

The present invention detects feature points based on image features from plural images which are consecutive in time series, and makes the feature points correspond to each other between images. At this occasion, each image is set to either of a key image 1000, and an ordinary image 1001 based on a constant rule. In corresponding of the feature points, a corresponding point of an image which is brought into a prescribed positional relationship with the key image is calculated.

For example, corresponding points of a key image 1000a and an image in a prescribed range 1002 are calculated.

A further specific configuration example of the present invention is an image generating method taking plural images which are consecutive over time by a camera and generating a single image from the plural images. According to the method, photographing condition data and image data are made to correspond to each other to store for respective plural images. Also, plural representative images are selected from the plural images. Further, an image having a prescribed relationship is selected as a relevant image based on the photographing condition data for each representative image, and the representative image and the relevant image having a prescribed relationship with the representative image are stored as an image pair. Further, corresponding points which are a set of the same points in the images of the image pair are calculated for each image pair. Further, the plural images are synthesized by using the corresponding points, and a single image is generated.

In setting the key image, plural images are processed in a time series order, in a case where a number of frames from a representative image set at an immediate vicinity to a current image is a prescribed threshold, the current image is set to the representative image. Or, the plural images are processed in the time series order, a positional relationship between the representative image set at the immediate vicinity and the current image is calculated based on the photographing condition data, and in a case where positions of the both images are remote from each other by a prescribed threshold or more, the current image is set to the representative image. Or, a key image setting and a corresponding point searching are made to be sequential processes, plural images are configured to be processed in the time sequential order, and a number of corresponding points is fed back from the corresponding point searching process to the key image setting process. Further, in a case where a number of the corresponding points which are fed back is equal to or smaller than a prescribed threshold, an image which is being processed is set to a representative image.

An image generating apparatus which is other aspect of the present invention includes camera acquiring image data by taking an image of an object within a prescribed image taking range, and a camera configured such that arbitrary single image data includes an object the same as those of plural image data pieces when plural image data pieces are acquired. Further, the image generating apparatus includes a feature point sampling unit for sampling a feature point from image data, a feature database storing information of feature points in correspondence with the image data, and a sensor acquiring sensor information related to at least one of a position, a speed, an acceleration, and an attitude of the camera when the camera acquires the image data. Further, the image taking apparatus includes an image pair selecting unit for selecting plural representative images from plural image data pieces, selecting a relevant image for each representative image based on the sensor information, and generating an image pair comprising a set of the representative image and the relevant image, and a corresponding point searching unit generating corresponding point information by making feature points correspond to each other in a case where feature points included in image data of the image pair are determined to be the same object. Further, the image generating apparatus includes an image position adjusting unit for generating adjustment information of positions of plural images based on the corresponding point information, and an image synthesizing unit for generating a single image from the plural images based on the adjustment information.

It is preferable that at least one of a condition of selecting a representative image or a condition of selecting a relevant image is made to be able to be changed in accordance with a situation. For example, the condition can be made to be controlled in accordance with an input from a control terminal by an operator.

Respective processes having configurations described above can be realized by software operated by a single computer including an input device, an output device, a processing device, and a storing device. Or, an arbitrary portion of an input device, an output device, a processing device, or a storing device may be configured by other computer connected by a network.

According to the present invention, a mosaic image having little distortion can be generated at high speed since corresponding points are detected among smaller number of images even in a case of taking images of a large amount of time series images.

### BRIEF DESCRIPTION OF THE DRAWINGS

FIGS. 1A and 1B are conceptual views showing a concept of a general mosaic image generating process;

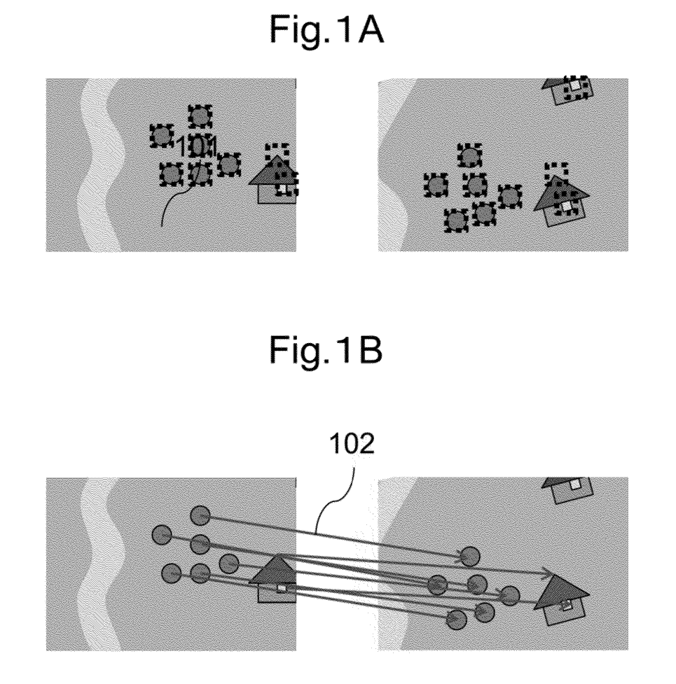

FIGS. 2A and 2B are conceptual views representing a correction of an error of a mosaic image by a bundle adjustment method;

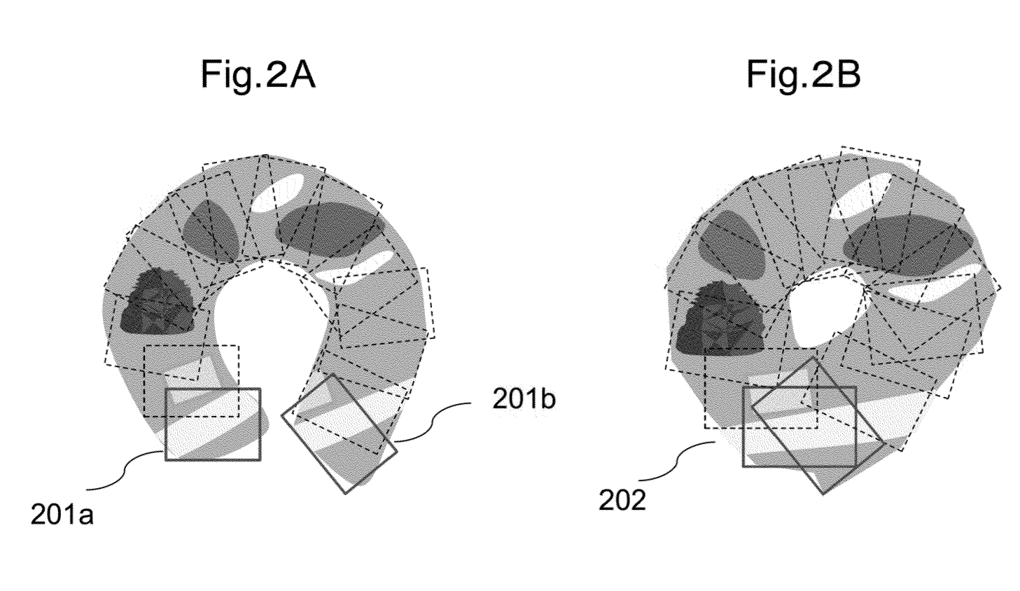

FIG. 3 is a schematic view showing an example of an application mode of a mosaic image generating apparatus;

FIG. 4 is a block diagram showing a configuration of a mosaic image generating apparatus;

FIG. 5 is a block diagram showing a configuration of a feature point sampling unit;

FIG. 6 is a table diagram showing a structure of a feature DB;

FIG. 7 is a configuration view showing an image pair selecting unit;

FIG. 8 is a table diagram showing a structure of an image setting DB;

FIG. 9 is a table diagram showing a structure of a frame information DB;

FIG. 10 is a flowchart showing a flow of a key image setting process;

FIG. 11 is a flowchart showing a flow of an image pair generating process;

FIG. 12 is a flowchart showing a flow of a corresponding point searching process;

FIG. 13 is a table diagram showing a structure of a corresponding point DB;

FIGS. 14A and 14B are schematic views for explaining an outline of a bundle adjustment;

FIG. 15 is a block diagram showing a configuration of an image synthesizing unit;

FIG. 16 is a block diagram showing a configuration of an image pair generating unit;

FIG. 17 is a flowchart showing a flow of a key image setting process;

FIG. 18 is a flowchart showing a flow of a key image setting process;

FIG. 19 is a block diagram showing a configuration of a mosaic image generating apparatus;

FIG. 20 is a block diagram showing a configuration of an image pair FIFO;

FIG. 21 is a block diagram showing a configuration of an image pair generating unit;

FIG. 22 is a flowchart showing a flow of an image pair generating process;

FIG. 23 is a graph diagram showing an effect of a processing load adjustment of a corresponding point retrieving process;

FIG. 24 is a conceptual view of the present invention; and

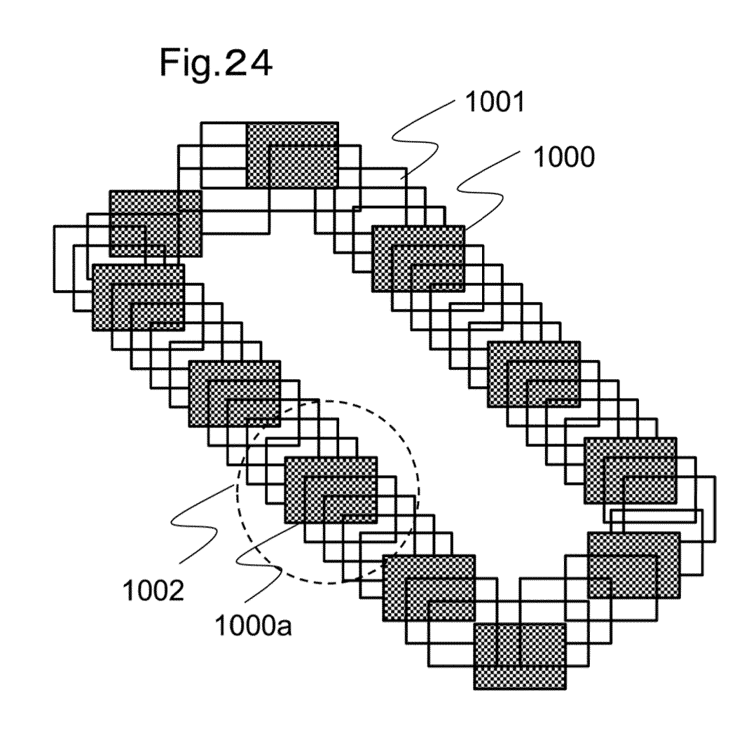

FIGS. 25A and 25B are conceptual views of a corresponding point number determining process.

### DETAILED DESCRIPTION OF THE PREFERRED EMBODIMENTS

A detailed explanation will be given of embodiments in reference to the drawings as follows. However, the present invention is not to be interpreted by limiting the present invention to description contents of embodiments shown below. The skilled person can easily understand that a specific configuration of the present invention can be changed within a range not deviated from the thought or the gist of the present invention.

In the configuration of the invention explained below, there is a case where the same notation is used at the same portion or a portion having a similar function commonly among different drawings and a duplicated explanation thereof is omitted.

An expression of “first”, “second”, “third” or the like in the present specification is attached for identifying a constituent element and does not necessarily limit a number or an order.

There is a case where a position, a size, a shape, a range or the like of each configuration shown in the drawing or the like does not represent an actual position, an actual size, an actual shape, and an actual range or the like to facilitate to understand the invention. Therefore, the present invention is not necessarily limited to a position, a size, a shape, a range or the like disclosed in a drawing or the like.

A publication, a patent, and a patent application cited in the present specification configure portions of an explanation of the present specification as they are.

### First Embodiment

An example of embodiments of the present invention will be shown as follows.

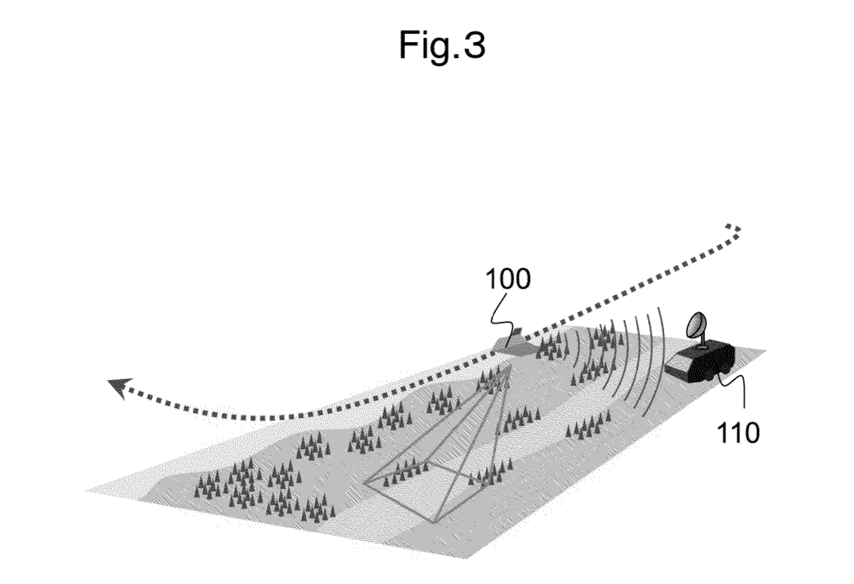

FIG. 3 is a schematic view representing an example of an application mode of the present apparatus.

As an example of the application mode of the present apparatus, there is conceivable a configuration of mounting a camera to a flying machine 100 and installing a mosaic image generating apparatus and a display apparatus at a ground station 110. As the flying machine, not only an airplane, but a helicopter, an artificial satellite or the like is applicable.

Incidentally, other than a configuration of mounting the mosaic image generating apparatus on a side of the flying machine 100, a function of the mosaic image generating apparatus may be mounted dividedly on the side of the flying machine 100 and on the side of the ground station 110. Also, the function may be mounted dividedly on the ground station 110 and a server connected thereto via a network.

Also, the present invention is not limited to an air photographed image by a flying machine, but is applicable to an image continuously taken by a moving camera or a camera a photographing direction of which is changed. For example, photographing by a camera which is attached to a front end of a movable arm and is movable three-dimensionally will do. Also, photographing by a camera an attaching position of which is fixed and which is rotatable centering on a prescribed axis will do. Further, the present invention is not limited to ordinary photographing but a very small object or an object at a remote place may be photographed by also using a microscope or a telescope.

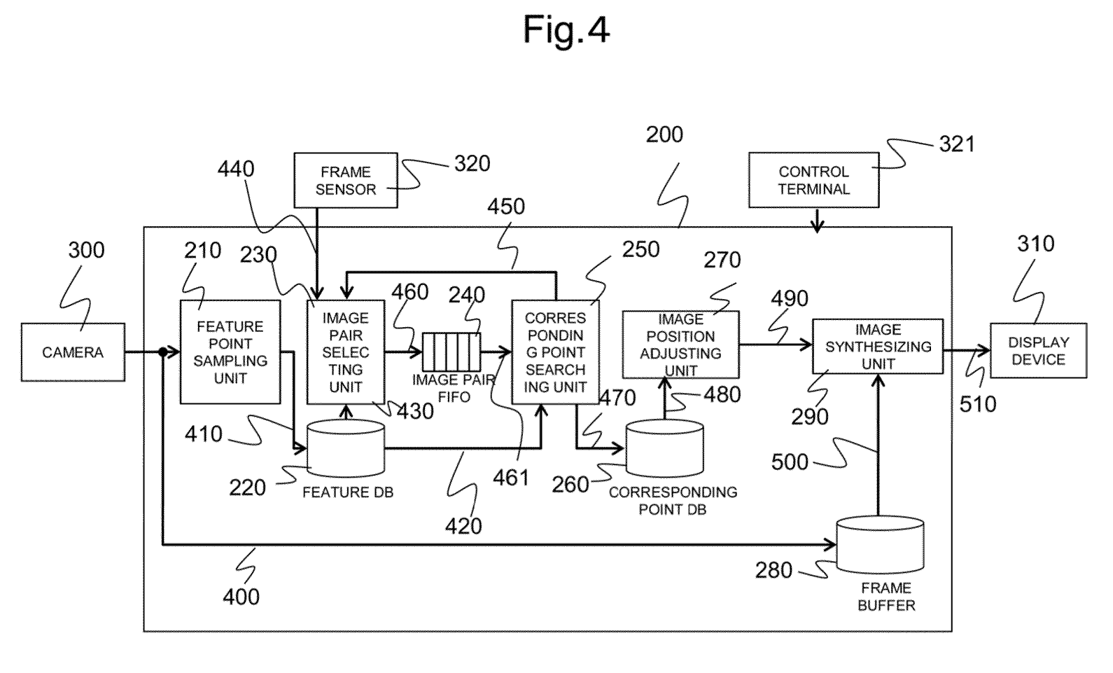

FIG. 4 is a view showing a configuration of a mosaic image generating apparatus.

A mosaic image generating apparatus 200 according to the present invention includes a feature point sampling unit 210, a feature DB 220, an image pair selecting unit 230, an image pair FIFO 240, a corresponding point searching unit 250, a corresponding point DB 260, an image position adjusting unit 270, a frame buffer 280, and an image synthesizing unit 290.

A camera 300 takes an object image at arbitrary time intervals, sends a taken image 400 to the feature point sampling unit 210, and at the same time, writes the taken image 400 to the frame buffer 280. Incidentally, the image taken by the camera 300 may once be stored to a storing device, and then, the taken image may be inputted to the feature point sampling unit 210.

The feature point sampling unit 210 inputs the taken image 400 from the camera 300, samples a feature point from within the image, and writes the feature point to the feature DB 220 as feature information 410.

The feature DB 220 stores the feature information 410 stringed with an image number, and outputs feature information 420 of the object image to the image pair selecting unit 230 and outputs feature information 430 of the object image to the corresponding point searching unit 250 as needed.

The image pair selecting unit 230 inputs the feature information 430 from the feature DB 220, inputs sensor information 440 from a frame sensor 320 at outside of the apparatus, inputs correspondence information 450 from the corresponding point searching unit 250, and pushes image pair information to the image pair FIFO 240.

The image pair FIFO 240 inputs the image pair information 460 from the image pair selecting unit 230, buffers the image pair information 460 at an inside thereof, and outputs image pair information 461 to the corresponding point searching unit 250.

The corresponding point searching unit 250 inputs image pair information 461 from the image pair FIFO 240, makes feature points correspond to each other between images prescribed by the image pair information 461, and outputs corresponding point information 470 between images to the corresponding point DB 260, and outputs correspondence information 450 to the image pair selecting unit 230.

The corresponding point DB 260 stores the corresponding point information 470 between respective images inputted from the corresponding point searching unit 250, and outputs corresponding point information 480 to the image position adjusting unit 270 as needed.

The image position adjusting unit 270 adjusts total image positions from the corresponding point information 480 among the respective images inputted from the corresponding point DB 260 such that there is no contradiction in relationships among the respective images, and outputs image position information 490 to the image synthesizing unit 290.

The frame buffer 280 buffers the taken image 400 inputted from the camera 300, and outputs a taken image 500 to the image synthesizing unit 290 as needed.

The image synthesizing unit 290 synthesizes a mosaic image 510 from the image position information 490 inputted from the image position adjusting unit 270, and the taken image 500 within the frame buffer 280 to output to the display device 310.

The display device 310 presents the inputted mosaic image 510 to a user.

A control terminal 321 is configured such that an operator can input various commands from an input device of a keyboard or the like.

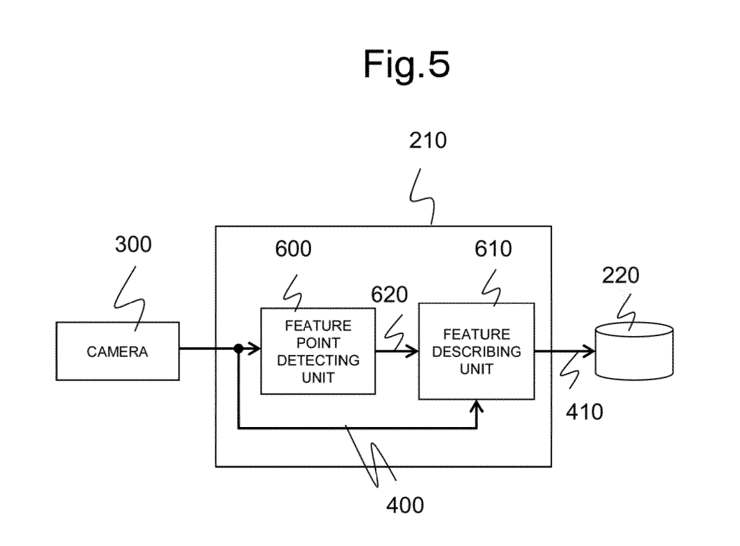

FIG. 5 is a diagram showing a configuration of the feature point sampling unit 210.

The feature point sampling unit 210 is configured by a feature point detecting unit 600 and a feature describing unit 610.

The feature point detecting unit inputs the taken image 400 from the camera 300, detects a feature point based on a publicly-known Features from Accelerated Segment Test (FAST) feature amount from inside of the taken image 400, and outputs information of the detected feature point to the feature describing unit 610 as feature point information 620.

The feature describing unit 610 inputs the feature point information 620 from the feature point detecting unit 600, makes a surrounding light and shade pattern or the like as a feature descriptor by publicly-known Binary Robust Independent Elementary Features (BRIEF) feature description, combines an image number which is uniquely provided for each taken image, the feature point information 620, and the feature description information as feature information 410 to be outputted to the feature DB 220.

Incidentally, although according to the present embodiment, the FAST feature is used at the feature point detecting unit 600, and the BRIEF feature description is used at the feature describing unit 610, the description is not limited thereto so far as the description is based on a method which can detect image feature and describe the feature.

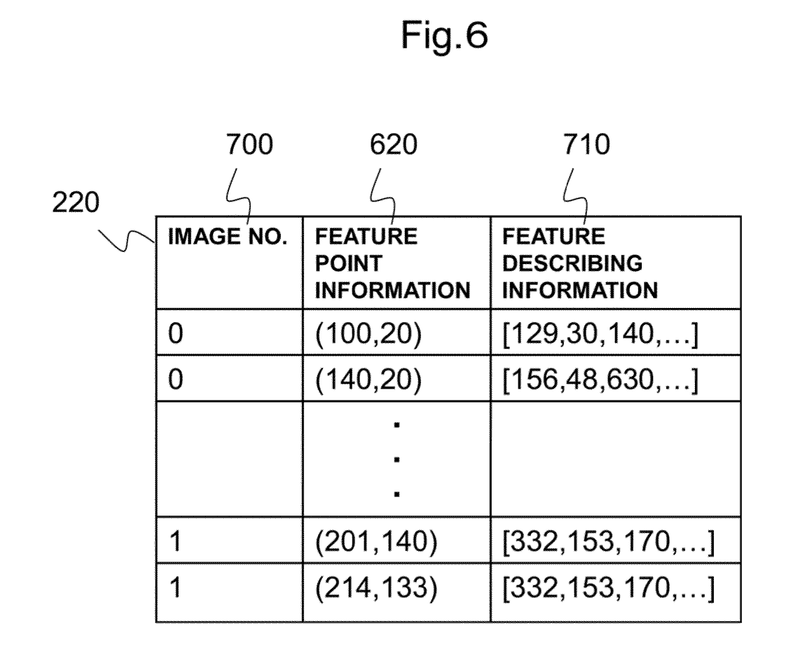

FIG. 6 is a diagram showing a data structure of the feature DB 220.

The feature DB 220 records the feature information 410 inputted from the feature point sampling unit 210, and outputs the feature information 420 and the feature information 430 in accordance with requests of the image pair selecting unit 230 and the corresponding point searching unit 250.

An image number 700 is a number which is uniquely provided for each taken image, by which the feature point information 620 and the feature describing information 710 can be specified to be the feature of which taken image 400.

As the simplest way of attaching the image number 700, there is conceivable a method of attaching the number in an order of an increase from start of photographing.

The feature information 620 is information concerning each feature point per se of a coordinate of a feature point, or a direction of a corner or the like, and specifies the feature point.

The feature describing information 710 is sequences of plural dimensions representing the surrounding light and shade situation or the like of the feature point, and in BRIEF feature description, there are a number of elements of 128 dimensions or 256 dimensions. The feature describing information 710 reflects a feature of an image at a surrounding of a feature point.

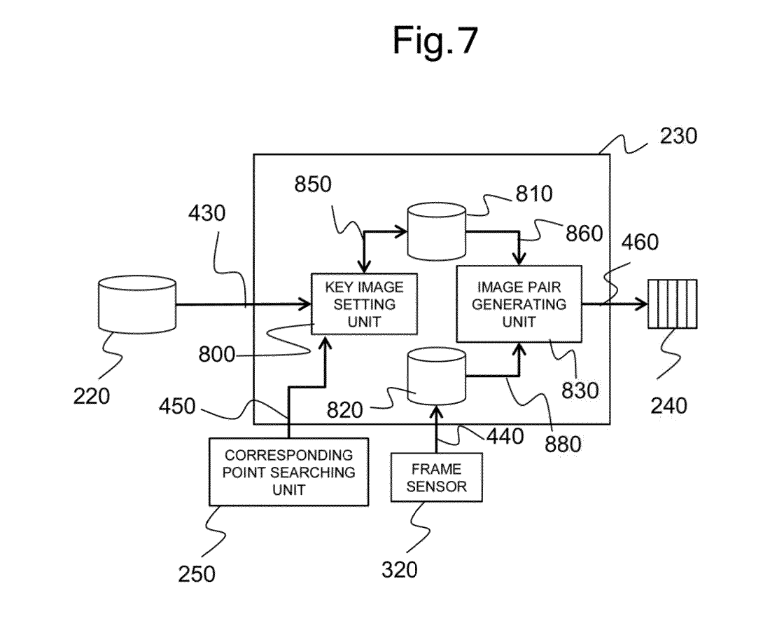

Incidentally, although according to the present embodiment, the feature DB 220 is configured to store the FAST feature amount and the BRIEF feature description, the configuration is not limited thereto so far as the configuration can record the feature information 410 outputted from the feature point sampling unit 210. FIG. 7 is a configuration diagram showing the image pair selecting unit 230.

The image pair selecting unit 230 is configured by a key image setting unit 800, an image pair generating unit 830, an image setting DB 810, and a frame information DB 820.

The key image setting unit 800 inputs feature information 430 of each image from the feature DB 220, correspondence information from the corresponding point searching unit 250, and image setting information 850 from the image setting DB 810, determines whether a current image is made to be a key image based on a key image setting process, and outputs a determination result to the image setting DB 810 as image setting information 850.

The image setting DB 810 inputs the image setting information 850 from the key image setting unit 800, and when stored to an inside thereof, outputs the image setting information 860 in accordance with a request of the image pair generating unit 830.

The image pair generating unit 830 inputs the image setting information 860 from the image setting DB 810, and the frame information 880 from the frame information DB 820, carries out an image pair generating process, and outputs a result to the image pair FIFO 240 as image pair information 460.

The frame information DB 820 inputs sensor information 440 at a time point of each image photographing from the frame sensor 320, stores an image number and the sensor information 440 as frame information, and outputs the frame information 880 in accordance with a request of the image pair generating unit 830.

As the frame information, it is preferable to acquire information concerning a camera per se ideally. However, for example, in a case where the camera is mounted on an airplane, a moving speed of the camera can be regarded as the same as a moving speed of the airplane, and therefore, the moving speed of the airplane may be made to be the frame information. The same goes with other information of an attitude, acceleration or the like. Concerning information of an angle of a camera, for example, xyz axes are fixed in an airplane, and an angle of the camera relative to the xyz axes is calculated. Further, for example, the xyz axes are defined on the ground surface, and an attitude of the airplane relative to the xyz axes is calculated. An angular relationship between the camera and the ground surface is calculated by a geometrical calculation from the angle of the camera and the attitude of the airplane obtained.

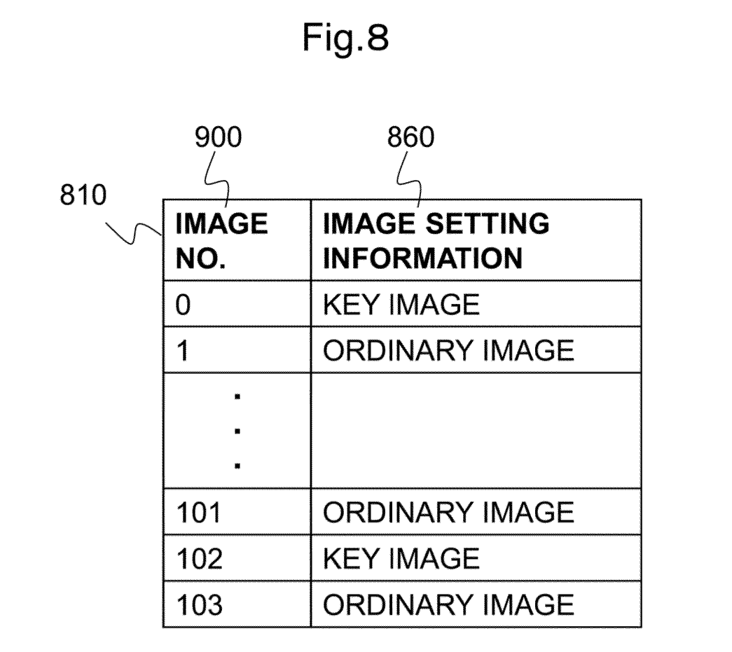

FIG. 8 is a diagram showing a data structure of the image setting DB 810.

The image setting DB 810 records the image number and the image setting information 850 inputted from the key image setting unit 800, and outputs the image setting information 860 in accordance with a request of the image pair generating unit 830.

An image number 900 is a number which is uniquely provided for each taken image, and is a number the same as that stored in the feature DB 220.

The image setting information 860 is information indicating whether the image is set to a key image or an ordinary image by the key image setting unit 800.

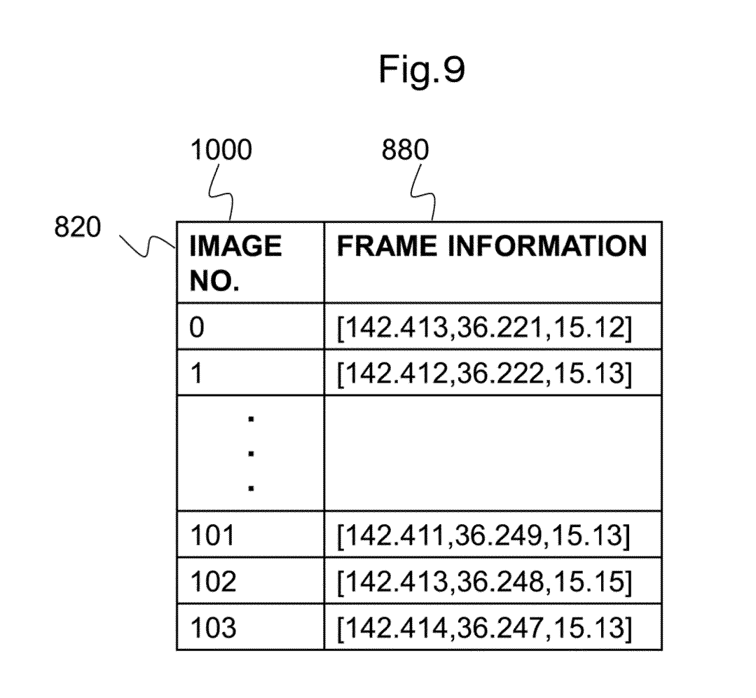

FIG. 9 is a diagram showing a structure of the frame information DB 820.

The frame information DB 820 records the image number 1000 and the frame information 880 inputted from the frame sensor 320, and outputs the frame information 880 in accordance with a request of the image pair generating unit 830.

The image number 1000 is a number which is uniquely provided for each taken image, and is a number the same as that stored in the feature DB 220 and the image setting DB 810.

The frame information 880 is sensor information 440 of various sensors inputted from the frame sensor 320, and here, the frame information 880 is information of latitude and longitude by GPS measurement.

According to the embodiment of the present invention, although the frame information 880 is the latitude and the longitude by the GPS measurement, otherwise, a content of information to be stored is not limited thereto so far as the information is sensor information used for the key image setting process and an image pair generating process of an attitude by the GPS measurement, three axes angular velocities and an angular acceleration by a gyroscope, a terrain clearance indicator, a ground speed or the like by a barometer.

Next, an explanation will be given of the key image setting process.

The key image setting unit 800 inputs the feature information 430 from the feature DB 220, the corresponding point number from the corresponding point searching unit 250, and image setting information 850 from the image setting DB 810, and outputs the image setting information 850 to the image setting DB 810.

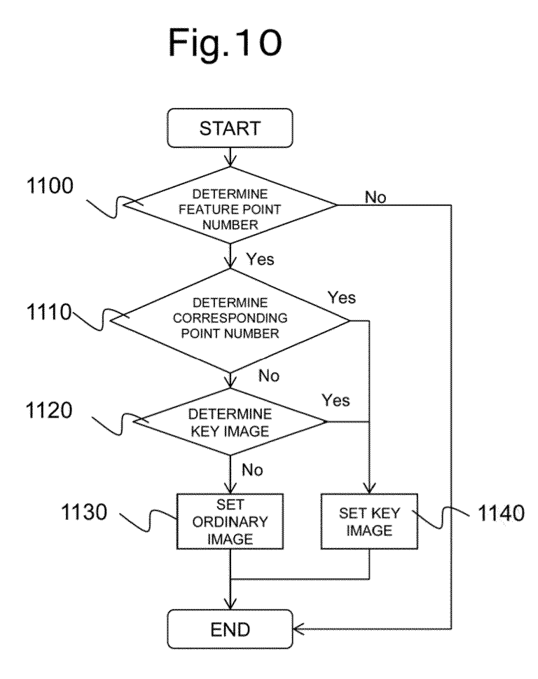

FIG. 10 is a diagram showing a flow of the key image setting process at the key image setting unit 800.

The key image setting process first executes a feature point number determining process 1100.

In the feature point number determining process 1100, when the feature point number of the feature information 430 inputted from the feature point sampling unit 210 is equal to or more than a feature point number threshold TF, a corresponding point number determining process 1110 is executed. When the feature point number is less than the feature point number threshold TF, the process is finished. An image which does not have a prescribed amount of feature points is not suitable for searching corresponding points, and therefore, the image is determined not to be used for a process thereafter. The feature point number determining process 1100 can also be omitted depending on a property of an image to be processed. Also, the feature point number determining process 1100 has an effect of reducing a corresponding point searching process amount when the feature point number determining process 1100 is carried out before a corresponding point searching process, and therefore, the feature point number determining process 1100 may be carried out after the corresponding point number determining process 1110.

As a way of thinking of a key image selection, it is efficient to select images respectively having different features. Similar images have a possibility of being geographically duplicated images. When corresponding points are searched by regarding such an image as a key image, a process amount is increased wastefully.

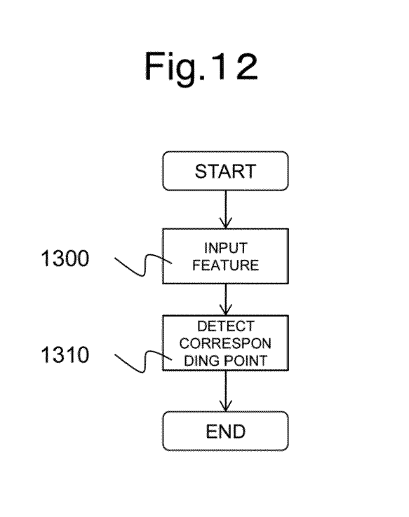

At the corresponding point number determining process 1110, when the corresponding point number inputted from the corresponding point searching unit 250 is equal to or more than the corresponding point number threshold TP, the key image determining process 1120 is executed. When the corresponding point number is less than the corresponding point number threshold TF, a key image setting process 1140 is executed. At the corresponding point searching unit 250 which will be explained later in reference to FIG. 12, corresponding points are searched between the image pairs generated by the image pair selecting unit 230. In a case where the corresponding point number is reduced to be less than the threshold TF, it is preferable to increase a frequency of the corresponding point searching. Hence, in a case of bringing about such a state, the image is made to be the key image, and the frequency of searching the corresponding point is increased.

At the image key image determining process 1120, the image setting information 850 is inputted from the image setting DB 810, and when a number of frames from the key image set at an immediate vicinity in a time series order to a current image is equal to or more than the key image determining threshold TK, the key image setting process 1140 is executed, and when less than the key image determining threshold TK, an ordinary image setting process 1130 is executed.

As an example of an image suitable as a key image, it is preferable to stably sample images remote from each other in view of a distance. In a case where a number of frames from the key image at an immediate vicinity is equal to or more than the threshold TK, it can be predicted that images of an image pair are images remote from each other in view of a distance. Hence, in a case of bringing about such a state, a frequency of appearance of an image pair is increased by regarding the image as the key image unconditionally.

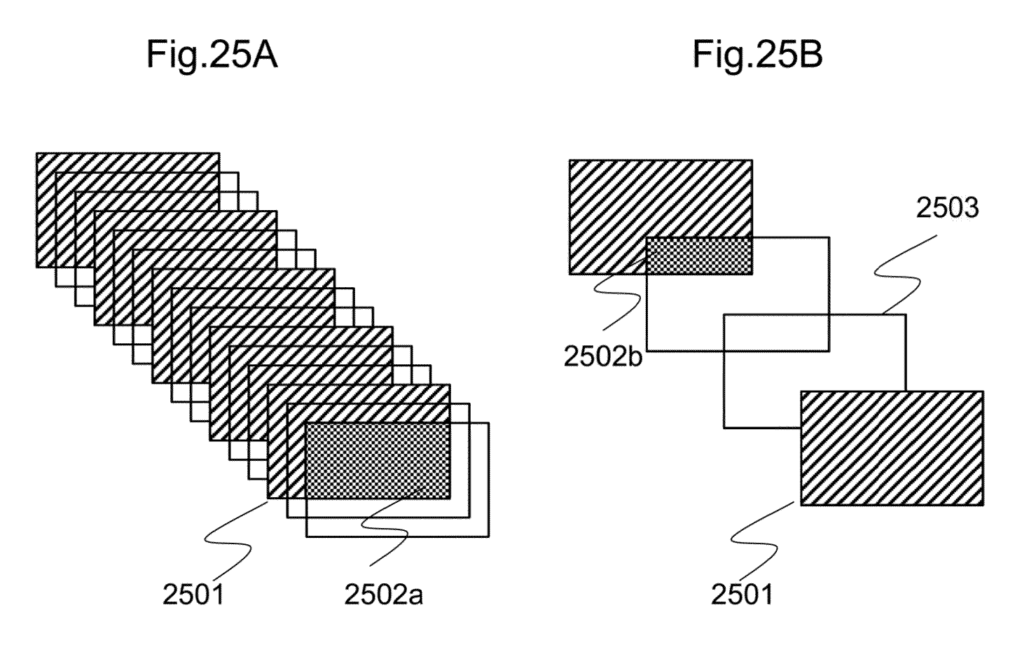

An explanation will be given of an example of the corresponding point number determining process 1110 in reference to FIGS. 25A and 25B. Rectangles in the drawings indicate plural image areas on the ground surface taken by, for example, an airplane. In a case where it is assumed that feature points are uniformly distributed in respective images, the corresponding point number has a correlation with an area of overlapping the images. FIG. 25A shows a case where an interval between the images is short and FIG. 25B shows a case where the interval between the images is long. For example, in a case of photographing at prescribed time intervals from an airplane, FIG. 25A corresponds to a case where the speed of the airplane is slow, and FIG. 25B corresponds to a case where the speed of the airplane is fast.

In the key image determining process 1120, when the key image determining threshold TK is 3, key images 2501 indicated by hatchings are set at an interval indicated by the drawing. Here, areas 2502a and 2502b where the key images overlap contiguous images are wide in FIG. 25A, and narrow in FIG. 25B. When the key image determining threshold TK stays to be 3, at FIG. 25B, an interval of the key images are excessively wide, and there is a possibility that a loop of the images cannot be configured. Hence, in a case where the corresponding point number is less than the corresponding point number threshold TP, the key image setting process 1140 is executed, and the image 2503 is made to be the key image.

The corresponding point number determining process 1110 can also be omitted in a case where the interval between the images is stable. In this case, a feedback path from the corresponding point searching unit 250 of FIG. 4 is unnecessary. Although according to the configuration of FIG. 4, a series of processes are continuously carried out, in a case of omitting the feedback path, the series of processes can also be configured in batch. For example, it is possible to select once the image pair, store data, and carry out the corresponding point searching process by reading the data thereafter.

In the ordinary image setting process 1130, the image setting information 850 is outputted as the ordinary image, and the key image setting process is finished.

In the key image setting process 1140, the image setting information 850 is outputted as the key image, and the key image setting process is finished.

Incidentally, the feature point number threshold TF, the key image determining threshold TK, and the corresponding point number TP are set by, for example, an operator from outside of the mosaic image generating apparatus.

Further, the content of the key image setting process is not limited to the above-described. Also, in the flow shown in FIG. 10, an order of processing the corresponding point number determining process 1110, and the key image determining process 1120 can be switched. Further, depending on conditions, either one of the corresponding point number determining process 1110 and the key image determining process 1120 can be omitted.

Next, an explanation will be given of the image pair generating process.

The image pair generating unit 830 inputs the image setting information 860 from the image setting DB 810, inputs the frame information 880 from the frame information DB 820, and outputs the image pair information 460 to the image pair FIFO 240.

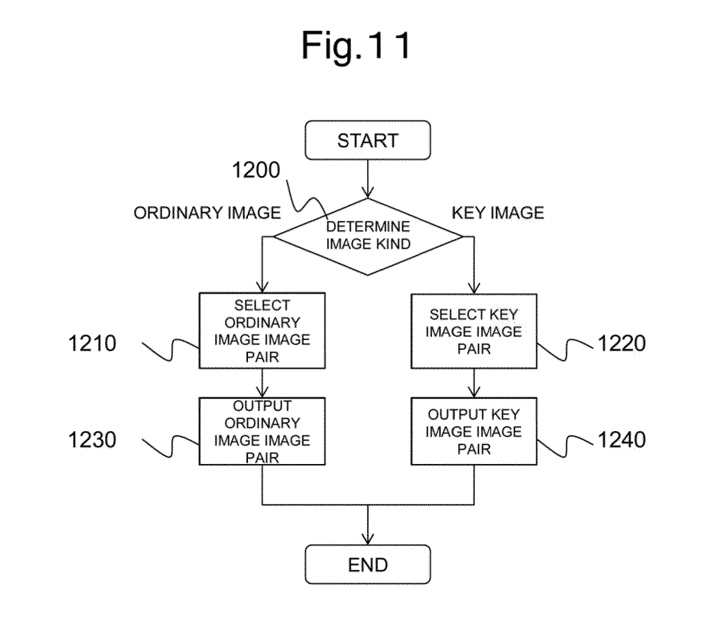

FIG. 11 is a diagram showing a flow of the image pair generating process at the image pair generating unit 830. In this flow, for example, the process is carried out in an order of an increase in the image number.

In the image pair generating process, first, an image kind determining process 1200 is executed.

At the image kind determining process 1200, the image setting information 860 is inputted from the image setting DB 810, when the current image is the key image, a key image pair selecting process 1220 is executed, and when the current image is the ordinary image, an ordinary image pair selecting process 1210 is executed.

In the key image pair selecting process 1220, the ordinary image in which the image taking position is present within a constant range of the current frame is selected as a candidate of the ordinary image pair from the image setting information 860 and the frame information 880, and a key image image pair outputting process 1240 is executed.

In the key image image pair outputting process 1240, when a number of the ordinary image pair candidate is larger than the key image image pair number TNK, an amount of the key image image pair number TNK of the candidates are selected in an order of a vicinity in the position information.

At this occasion, when plural images having the same position are present, an image at a vicinity in the time series order has a priority.

Further, an image ID of each ordinary image image pair candidate and an image ID of a key image are combined to be image pair information 460 to be outputted to the image pair FIFO 240.

At the ordinary image image pair selecting process 1210, the key image within a constant range from the current image is selected as a key image image pair candidate from the image setting information 860 and the frame information 880, and an ordinary image image pair outputting process 1230 is executed.

In the ordinary image image pair outputting process 1230, when a number of the key image image pair candidates is larger than the ordinary image image pair number TNN, an amount of an ordinary image image pair number TNN is selected in an order of a vicinity in position information.

At this occasion, when there are present plural images having the same position, an image at a vicinity in the time series order has a priority.

Further, an image ID of each key image image pair candidate and an image ID of the ordinary image are combined to be outputted to the image pair FIFO 240 as the image pair information 460.

Incidentally, the key image image pair number TNK and the ordinary image image pair number TNN are set from outside of the mosaic image generating apparatus.

Further, although in the explanation described above, in the key image image pair selecting process 1220, the ordinary image is selected as the ordinary image image pair candidate, and in the ordinary image image pair selecting process 1210, the key image is selected as the key image image pair candidate, in the key image image pair selecting process 1220, the candidate may be selected without differentiating the key image from the ordinary image. Although an amount of calculation is increased by generating the image pair by the key images, there is a possibility of further reducing large area distortion.

Although in a prior art method, it is necessary to carry out corresponding point searching processes among all of the images, by the key image setting process and the image pair generating process according to the embodiment of the present invention, the key images are set at intervals equal to or less than a prescribed sheet number from the plural air photographed images sequences, the images other than the key image are set as the ordinary images, the corresponding points are detected between the key images per se and the key image and the ordinary image, thereby, a time period required for the corresponding point searching process described later can considerably be reduced.

This signifies that a corresponding relationship on the whole is calculated between the plural key images, and concerning the ordinary images, a positional relationship is calculated only between the ordinary image and the key image related to the ordinary image, and the corresponding point search between the ordinary images can be saved.

The corresponding point searching unit 250 inputs the image pair information 461 from the image pair FIFO 240, inputs the feature information 420 of the image included in the image pair information 470 from the feature DB 220, detects the corresponding point based on the feature information 630, and outputs the image pair information 461 and the corresponding point to the corresponding point DB 260 as the corresponding point information 470.

FIG. 12 is a diagram showing a flow of the corresponding point searching process in the corresponding point searching unit 250.

The corresponding point searching process first executes the feature inputting process 1300.

The feature inputting process 1300 inputs the image pair information 461 from the image pair FIFO 240 at a preceding stage, inputs the feature information 420 which coincides with two image ID's designated by the image pair information 470 from the feature DB 220, and carries out the corresponding point detecting process 1310.

At the corresponding point detecting process 1310, the feature describing information 710 of the two inputted images makes the most similar feature points correspond to each other, outputs the feature points as corresponding points and finishes the corresponding point searching process.

An explanation will be given of a process of a corresponding point detecting process between an image pair {N, M} as follows.

A feature describing information 710 of the image M in which the Hamming distance is the shortest is searched for the feature describing information 710 of the image N.

On the other hand, feature describing information 710 of the image N in which the Hamming distance is the shortest is searched similarly for the feature describing information 710 of the image N.

At this occasion, only a feature point pair in which results of searching from two directions of from the image N to the image M and from the image M to the image N coincide with each other is dealt with as corresponding points.

Further, when the corresponding point number detected between the image pair {N, M} is equal to or more than the set corresponding point threshold TM, it is determined that the image pair {N, M} are images photographing the same portion. At this occasion, the image pair {N, M} and all of the corresponding points detected between the image pair {N, M} are outputted to the image pair selecting unit 230 and the corresponding point DB 260 as the corresponding point information 470. Also, the detected corresponding point number is outputted to the image pair selecting unit 230 as the correspondence information 450.

Incidentally, the corresponding point number threshold TM is set by an operator from outside of the mosaic image generating apparatus.

The corresponding point DB 260 is recorded with the corresponding point information 470 outputted from the corresponding point searching unit 250, and the corresponding point information 470 is outputted as the corresponding point information 480 to the image position adjusting unit 270 as needed.

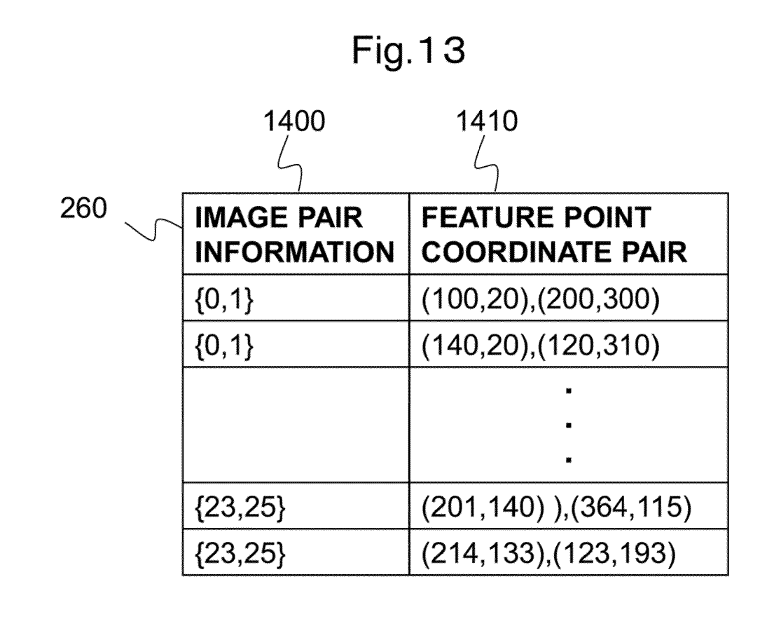

FIG. 13 is a diagram showing a structure of the corresponding point DB 260.

The image pair information 1400 represents an image number of an image pair which finds out the corresponding point, and a case of {0, 1} signifies a corresponding point between the image pair of the image numbers 0 and 1.

The image pair information {0, 1} has a meaning the same as that of {1, 0}, and therefore, {N, M} is set to be always N<M.

The feature point coordinate pair 1410 represents coordinates of the corresponding point, and feature point coordinates in the image N and feature point coordinates in the image M are recorded as a pair. For example, a feature point of coordinates of (100, 20) of the image number 0, and a feature point of coordinates of (200, 300) of the image number 1 have similar feature describing information 710, and are predicted to be the same object.

The image position adjusting unit 270 inputs corresponding point information from the corresponding point DB 260, calculates positions of respective images within a mosaic image by the bundle adjusting method to output the image position information 490 to the image synthesizing unit 290.

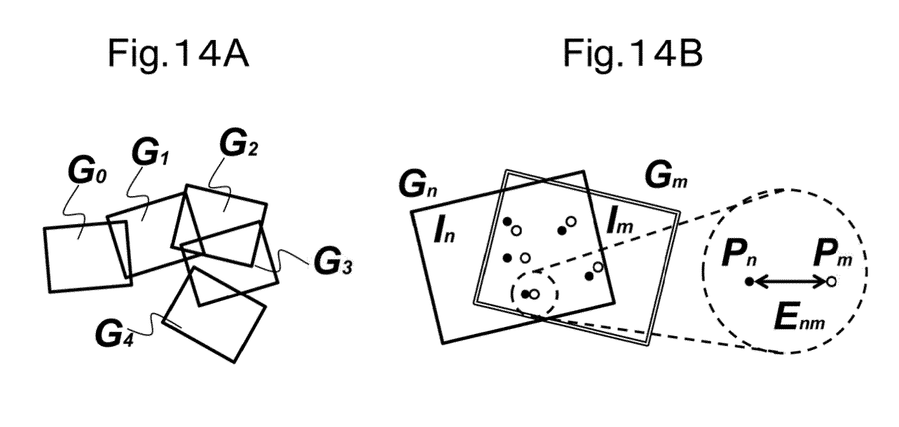

FIGS. 14A and 14B are conceptual views explaining with regard to an outline of the bundle adjustment executed at the image position adjusting unit 270.

As shown in FIG. 14A, according to the bundle adjusting method of the image position adjusting unit 270, a position of an image Ii is defined as a homography matrix Gi.

At this occasion, 8 parameters of the homography matrix are made to be unknown parameters, and a homography matrix Gi minimizing errors among the respective images is calculated by Levenberg-Marquardt method to be outputted as the image position information 490.

Concerning an error between the image pair {N, M}, in a case where coordinates of corresponding points in the respective images are made to be Bn and Bm, positions Pn and Pm of corresponding points in a mosaic image are calculated by the following equations.

Pᵢ=GᵢBᵢ Equation 3

As shown by FIG. 14B, an error between the image N and the image M is made to be L2 distance E nm between positions Pn and Pm of corresponding points in the mosaic image concerning all of corresponding points between the image N and the image M.

Eₙₘ=Σ(Pₙ−Pₘ)² Equation 4

However, G0 is fixed as a unit matrix in order to make an image position of an image of a first sheet as a reference.

The image synthesizing unit 290 inputs the taken image 500 from the frame buffer 280, inputs the image position information 490 from the image position adjusting unit 270, and outputs a mosaic image 510 to the display device 310.

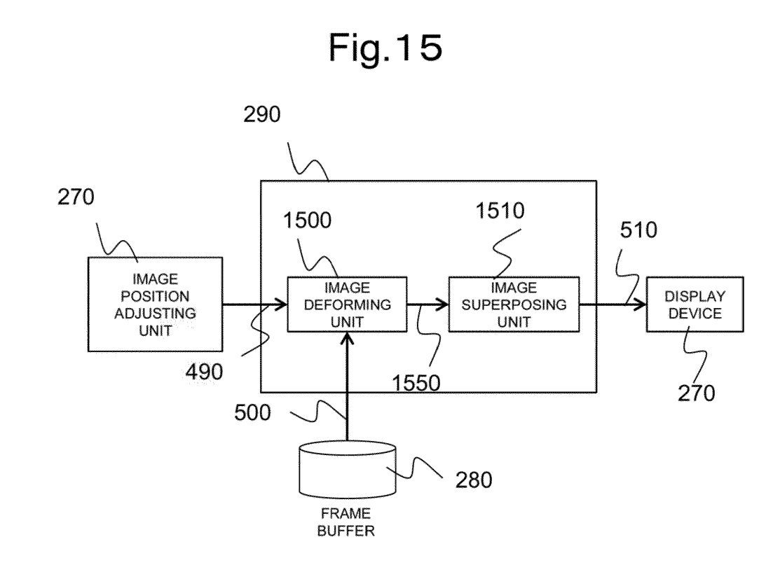

FIG. 15 is a diagram showing a configuration of the image synthesizing unit 290.

The image synthesizing unit 290 is configured by an image deforming unit 1500 and an image superposing unit 1510.

At the image deforming unit 1500, the image position information 490 is inputted from the image position adjusting unit 270, the air photographed image 500 is inputted from the frame buffer 280, the image is deformed in accordance with the image position information 490, and the image is outputted to the image superposing unit 1510 as a deformed image 1550.

At the image superposing unit 1510, the mosaic image is generated by superposing the deformed images 1510 inputted from the image deforming unit 1500, and the mosaic image 510 is outputted to the display device 310.

When the frame buffer 280 inputs the air photographed image 400 from the camera 300 to record to a buffer at inside thereof, the frame buffer 280 outputs the air photographed image 500 to the image synthesizing unit 290 in accordance with a request from the image synthesizing unit 290.

Although according to the prior art method, it is necessary to carry out corresponding point searching among a number of images, according to the present embodiment, image pairs for carrying out corresponding point searching can be narrowed by the image pair selecting unit 230, and therefore, enormous time required for the corresponding point searching process can considerably be reduced.

### Second Embodiment

Another embodiment of the present invention will be described below.

As a mosaic image generating apparatus 200 according to this embodiment is the same as that device in the first embodiment except an image pair selecting unit 230, its description is omitted.

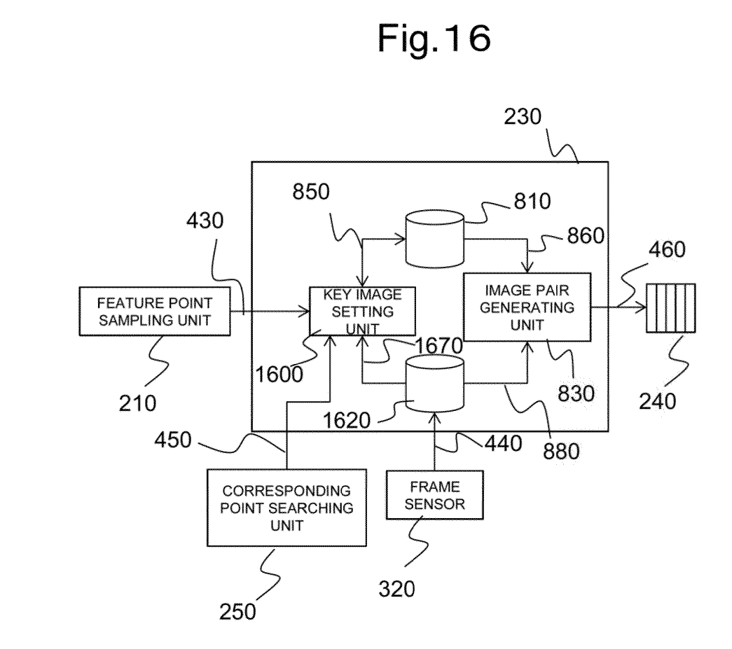

FIG. 16 shows another configuration of the image pair selecting unit 230. The same reference numeral is allocated to the same configuration as that in the example shown in FIG. 7, its description is omitted, and only different points will be mainly described below.

A frame information DB 1620 in this embodiment of the present invention outputs frame information 1670 in response to a request of a key image setting unit 1600.

As its data structure is the same as that in the first embodiment, its description is omitted.

The key image setting unit 1600 inputs the frame information 1670 from the frame information DB 1620 and utilizes it for internal processing.

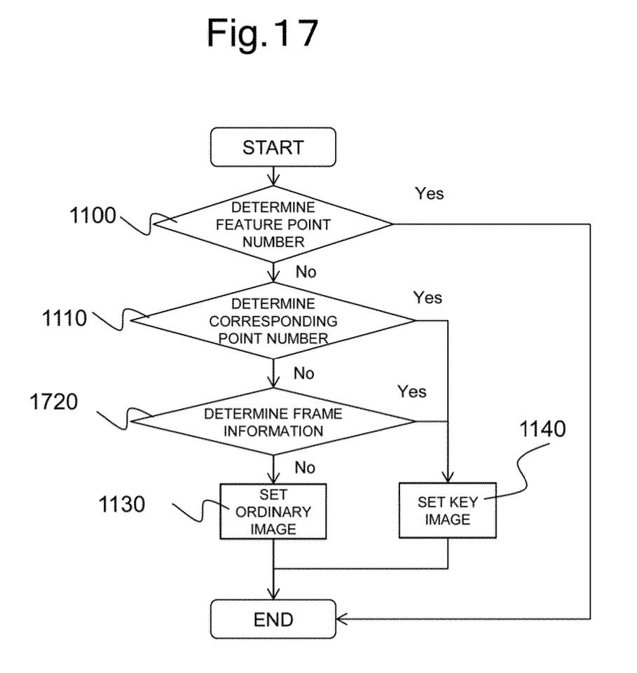

FIG. 17 shows a flow of a key image setting process in the key image setting unit 1600. The same reference numeral is allocated to the same step as that in the example shown in FIG. 10.

In the key image setting process, a feature point number determining process 1100 is first executed.

In the feature point number determining process 1100, when the number of feature points in feature information 430 input from a feature point sampling unit 210 is equal to or exceeds a threshold TF of the number of the feature points, a corresponding point number determining process 1110 is executed and when the number of the feature points is below the threshold TF of the number of the feature points, the process is finished.

In the corresponding point number determining process 1110, when the number of corresponding points 450 input from a corresponding point searching unit 250 is equal to or exceeds a threshold TP of the number of the corresponding points, A frame information determining process 1720 is executed and when the number of the corresponding points 450 is below the threshold TP of the number of the corresponding points, a key image setting process 1140 is executed.

In the frame information determining process 1720, frame information 1670 is input from the frame information DB 1620 and image setting information 850 is input from an image setting DB 810. When a position where the current image is acquired is apart from a position where a key image immediately before in the order of time series is acquired by or over a positional threshold TL, the key image setting process 1140 is executed and when the position of the current image is apart from the position of the key image by distance below the positional threshold TL, a normal image setting process 1130 is executed.

In the normal image setting process 1130, the image setting information 850 is output as a normal image and the key image setting process is finished.

In the key image setting process 1140, the image setting information 850 is output as a key image and the key image setting process is finished.

In this embodiment of the present invention, it is reduced by determining a key image using the frame information 1670 to newly set a key image though the same area is photographed and images scarcely vary. For utilizable frame information, if only the information is information to be material for judging whether images are acquired in different areas or not, no limit is provided. Besides, for an index showing a photographed position, various indexes are conceivable.

For example, used frame information shall be positional information acquired from GPS and others and when a photographed position of the current image is apart from a photographed position of the key image immediately before by or over a threshold in latitude and longitude, the key image setting process 1140 is executed.

Or used frame information shall be speed information and time information and when the photographed position of the current image calculated based upon information of speed and time is apart from the photographed position of the key image immediately before by or over a threshold, the key image setting process 1140 is executed.

Or used frame information shall be altitude and when photographed altitude of the current image is different from photographed altitude of a key image immediately before by or over a threshold, the key image setting process 1140 is executed.

Or used frame information shall be the inclination of a frame and when a photographed situation of the current image is different from a photographed situation of a key image immediately before by or over a threshold in inclination, the key image setting process 1140 is executed.

Or when the orientation of a camera is movable for A frame, an angle of the camera for the frame shall be frame information and when a photographed situation of the current image is different from a photographed situation of a key image immediately before by or over a threshold in the angle, the key image setting process 1140 is executed.

Besides, judgment may be also made in the combination of these pieces of frame information.

The feature point number threshold TF, the corresponding point number threshold TP and the positional threshold TL shall be set by a device outside the mosaic image generation device.

In the first embodiment, key images are set at an interval equal to or below a predetermined number from plural aerial image strings for example. However, when flying speed is slow or in the case of a duration flight, the same area may be photographed. Accordingly, even if images scarcely vary, a new key image may be set. According to this embodiment, when flying speed is slow or in the case of the duration flight, a new key image can be also prevented by using the frame information 1670 from being set though the same area is photographed and images scarcely vary. Accordingly, as a corresponding point searching process is performed only between fewer images, the processing time of the corresponding point searching process can be reduced, compared with the processing time of the corresponding point searching process in the first embodiment.

### Third Embodiment

Further another embodiment of the present invention will be described below.

As a mosaic image generation device according to this embodiment is the same as that device in the second embodiment except an image pair selecting unit, its description is omitted.

A key image setting unit 1600 inputs feature information 430 from a feature point sampling unit 210, the number of corresponding points 450 from a corresponding point searching unit 250 and image setting information 850 from an image setting DB 810, inputs frame information 1670 from A frame information DB 1620, and outputs image setting information 850 to the image setting DB 810.

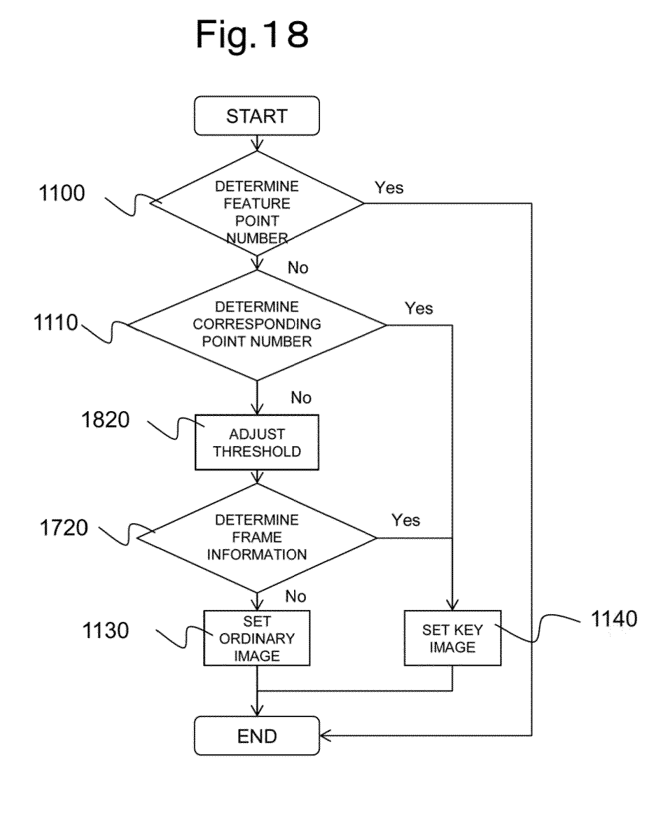

FIG. 18 shows a flow of a key image setting process in the key image setting unit 1600. The same reference numeral is allocated to the same configuration as the configuration shown in FIG. 17 and its description is omitted.

In a corresponding point number determining process 1110, when the number of corresponding points 450 input from the corresponding point searching unit 250 is equal to or exceeds a corresponding point number threshold TP, a corresponding point number threshold adjustment process 1820 is executed and when the number of corresponding points is below the corresponding point number threshold TP, a key image determining process 1140 is executed.

In the threshold adjustment process 1820, the frame information 1670 is input from the frame information DB 1620, a positional threshold TL is adjusted according to photographed altitude of the current image, and a frame information determining process 1720 is executed.

As for a method of adjusting the positional threshold TL, as a range of photography is also extended according to altitude when the altitude of photography is raised, the positional threshold TL is increased in proportion to the altitude of photography. In the meantime, as a range of photography is narrowed according to altitude when the altitude of photography is lowered, the positional threshold TL is decreased in proportion to the altitude of photography.

In the frame information determining process 1720, the frame information 1670 is input from the frame information DB 1620 and the image setting information 850 is input from the image setting DB 810. When a photographed position of the current image is apart from a photographed position of a key image immediately before in the order of time series by or over a positional threshold TL, the key image setting process 1140 is executed and when that of the current image is apart from that of the key image immediately before below the positional threshold TL, a normal image setting process 1130 is executed.

In this embodiment, a key image is prevented from being newly set by automatically adjusting the thresholds for determination in the frame information determining process 1720 using the frame information 1670 though the same area is photographed and images scarcely vary.

For example, in the frame information determining process 1720, a case that a new key image is set by using altitude information in the frame information 1670 when the altitude varies by or over a threshold of altitude variation is studied. In the threshold adjustment process 1820, the threshold of altitude variation is set to a large value in inverse proportion to information of an angle of view. That is, as the variation of a photographed range by the variation of altitude is great the larger the angle of view of a camera is, the threshold of altitude variation is set to a small value in inverse proportion to the angle of view of the camera. Conversely, as a photographed range does not greatly vary even if the altitude varies when the angle of view of the camera is small, the threshold of altitude variation is set to a large value in inverse proportion to the information of the angle of view.

For another example, in a case that a new key image is set using attitude information when the attitude varies by or over a threshold of attitude variation, the threshold of attitude variation is set according to information of an angle of view of a camera. That is, as a photographed range does not greatly vary even if the attitude varies when the angle of view is large, the threshold of attitude variation is set to a large value in proportional to the information of the angle of view. Conversely, as a photographed range greatly varies in a case that the attitude varies when the angle of view is small, the threshold of attitude variation is set to a small value in proportional to the information of the angle of view.

According to the second embodiment, cases that a new key image is set by using the frame information 1670 though the same area is photographed and images scarcely vary can be reduced, compared with the first embodiment. However, when flight altitude and an angle of view of a camera vary, a new key image is set even if images scarcely vary, conversely, variation between key images is too large, no corresponding point can be detected between the key images, the adjustment of bundles does not satisfactorily function, and mosaic images may be distorted. In this embodiment, the threshold of the frame information determining process 1720 is automatically adjusted according to the variation of frame information such as flight altitude and an angle of view. Hereby, as a key image can be suitably set and the image position adjustment process functions, the corresponding point searching process can be performed only between desired images. Accordingly, the processing time of the corresponding point searching process and the reduction of the distortion of mosaic images that are a result of output, which are in the relation of a trade-off, can be more suitably adjusted, and compared with the first embodiment and the second embodiment.

### Fourth Embodiment

Further another embodiment of the present invention will be described below.

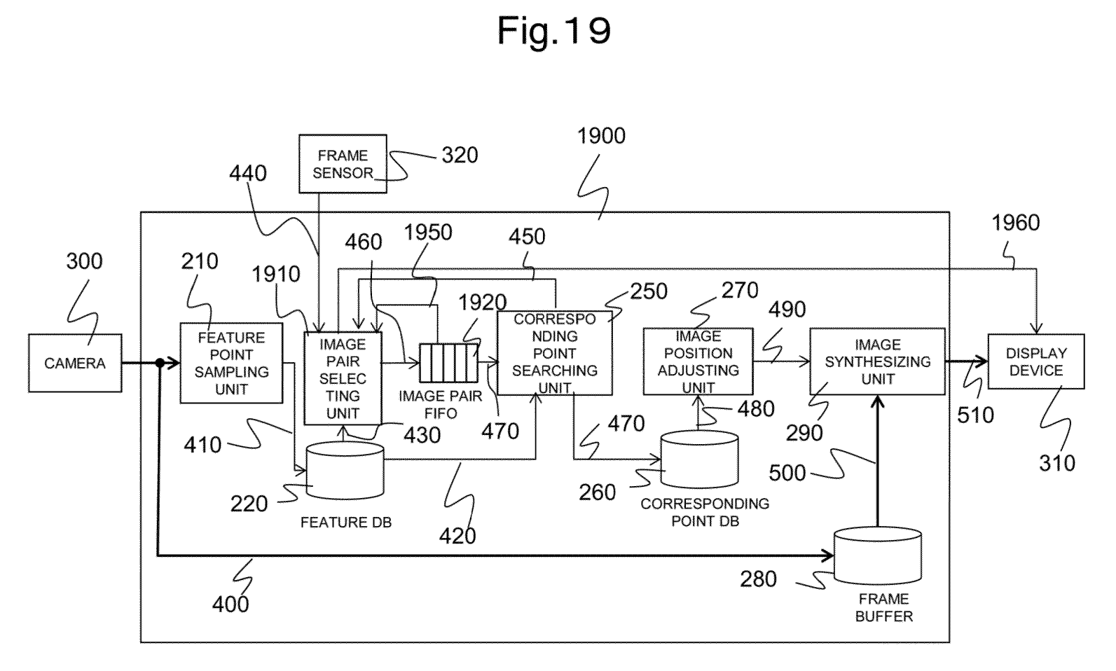

FIG. 19 shows the configuration of a mosaic image generation device 1900.

The mosaic image generation device 1900 according to the present invention is provided with a feature point sampling unit 210, a feature DB 220, an image pair selecting unit 1910, an image pair FIFO 1920, a corresponding point searching unit 250, a corresponding point DB 260, an image position adjusting unit 270, a frame buffer 280 and an image synthesizing unit 290.

As the mosaic image generation device 1900 in this embodiment of the present invention is the same as the third embodiment except the image pair selecting unit 1910 and the image pair FIFO 1920, its description is omitted.

The image pair selecting unit 1910 inputs feature information 430 from the feature DB 220, inputs sensor information 440 from a frame sensor 320 outside the device, inputs buffer information 1950 from the image pair FIFO 1920, inputs correspondence information 450 from the corresponding point searching unit 250, outputs buffer warning information 1960 to a display 510, and outputs image pair information 460 to the image pair FIFO buffer.

The image pair FIFO 1920 inputs the image pair information 460 from the image pair selecting unit 1910, buffers the image pair information 460 inside, outputs image pair information 470 to the corresponding point searching unit 250, and outputs the buffer information 1950 to the image pair selecting unit 1910.

The image pair FIFO 1920 inputs the image pair information 460 from the image pair selecting unit 1910, outputs the image pair information 470 to the corresponding point searching unit 250, and outputs the buffer information 1950 to the image pair selecting unit 1910.

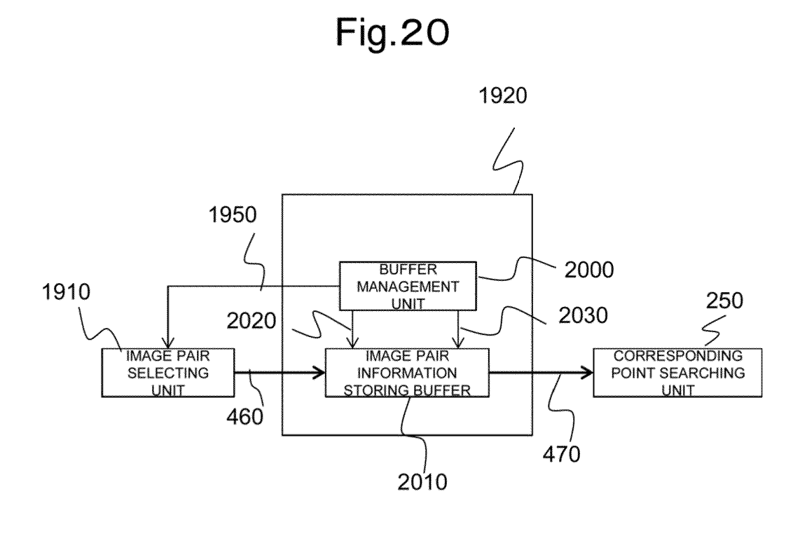

FIG. 20 shows the configuration of the image pair FIFO 1920.

The image pair FIFO 1920 according to the present invention is provided with a buffer manager 2000 and an image pair information storage buffer 2010.

The buffer manager 2000 outputs writing position information 2020 to the image pair information storage buffer 2010 every time the image pair information 460 is input from the image pair selecting unit 1910, updates the writing position information 2020, outputs reading position information 2030 to the image pair information storage buffer 2010 every time the image pair information 470 is output to the corresponding point searching unit 250, and updates the reading position information 2030.

The buffer manager 2000 updates the buffer information 1950 every time the writing position information 2020 and the reading position information 2030 are updated and outputs the updated buffer information to the image pair selecting unit 1910.

The image pair information storage buffer 2010 stores the image pair information 460 input from the image pair selecting unit 1910 in an area shown by the writing position information 2020 input from the buffer manager 2000 and outputs the image pair information 470 stored in an area shown by the reading position information 2030 input from the buffer manager 2000 to the corresponding point searching unit 250.

WP=WP+1((WP+1)<MP)

WP=0((WP+1)=MP) Equation 5

The buffer manager 2000 updates the writing position information 2020 according to the calculation of the mathematical expression 5 when the maximum number of the image pair information which can be stored in the image pair information storage buffer 2010 is MP and the writing position information 2020 immediately before is WP.

RP=RP+1((RP+1)<MP)

RP=0((RP+1)=MP) Equation 6

The buffer manager 2000 updates the reading position information 2030 according to the calculation of the mathematical expression 6 when the maximum number of image pair information which can be stored in the image pair information storage buffer 2010 is MP and the reading position information 2030 immediately before is RP.

BI=RP−WP(WP<=RP)

RP=MP−(WP−RP)(WP>RP) Equation 7

The buffer information 1950 is a value showing how many residual pieces of image pair information can be stored in the image pair information storage buffer 2010.

The update of the buffer information 1950 in the buffer manager 2000 is calculated according to the mathematical expression 7 when the maximum number of image pair information which can be stored in the image pair information storage buffer 2010 is MP and the buffer information 1950 is BI.

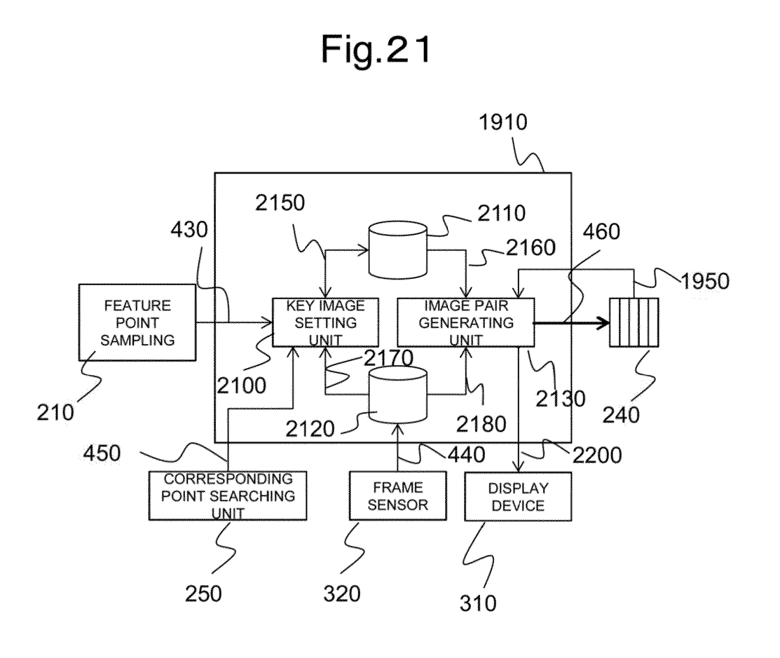

FIG. 21 shows the configuration of the image pair selecting unit 1910.

The image pair selecting unit 1910 is configured by a key image setting unit 2100, an image pair generating unit 2130, an image setting DB 2110 and a frame information DB 2120.

The key image setting unit 2100 inputs the feature information 430 every image from the feature point sampling unit 210, inputs the correspondence information 450 from the corresponding point searching unit 250, inputs image information 2150 from the image setting DB 2110, inputs frame information 2170 from the frame information DB 2120, determines whether the current image is to be a key image or not based upon a key image setting process, and outputs a result of the determination to the image setting DB 2110 as image setting information 2150.

The image setting DB 2110 inputs the image setting information 2150 from the key image setting unit 2100, stores it inside, and outputs image setting information 2160 in response to a request of the image pair generating unit 2130.

The image pair generating unit 2130 inputs the image setting information 2160 from the image setting DB 2110, inputs buffer information 1950 from an image pair FIFO 240, inputs frame information 2180 from the frame information DB 2120, executes an image pair generation process, outputs a result of selection to the image pair FIFO 240 as the image pair information 460, and outputs buffer warning 2200 to a display device 310 when the image pair FIFO 240 has a risk of buffer overflow.

The frame information DB 2120 inputs sensor information 440 when each image is photographed from the frame sensor 320, stores an image number and the sensor information 440 as frame information inside, outputs the frame information 2170 in response to a request of the key image setting unit 2100, and outputs the frame information 2180 in response to a request of the image pair generating unit 2130.

The image pair generating unit 2130 inputs the image setting information 2160 from the image setting DB 2110, inputs the buffer information 1950 from the image pair FIFO 240, inputs the frame information 2180 from the frame information DB 2120, and outputs the image pair information 460 to the image pair FIFO 240.

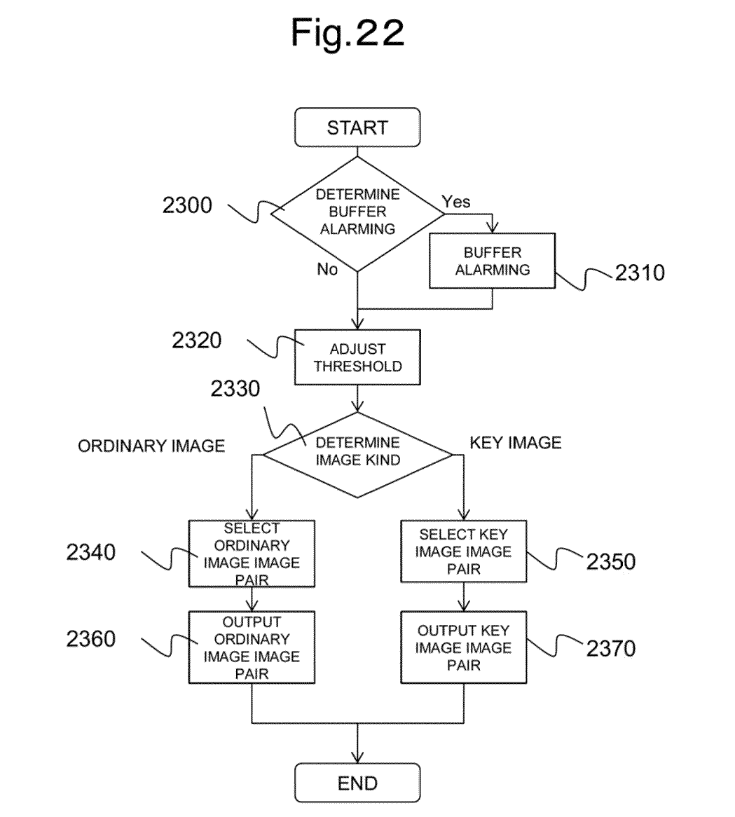

FIG. 22 shows a flow of the image pair generation process in the image pair generating unit 2130.

In the image pair generation process, a buffer warning determining process 2300 is first executed.

In the buffer warning determining process 2300, when the buffer information 1950 BI is equal to or exceeds a buffer warning threshold TBW, a threshold adjustment process 2320 is executed and when the buffer information 1950 BI is below the buffer warning threshold TBW, a buffer warning process 2310 is executed.

In the buffer warning process 2310, an error code for warning that a load in the corresponding point searching process is not in time and real time processing is hindered, information showing a recommended value of each set value in the key image setting unit 2100, a character string that recommends increasing operating resources of the corresponding point searching unit 250 and others are output to the display device 310 as the buffer warning 2200, and the threshold adjustment process 2320 is executed.

The buffer warning 2200 in this embodiment of the present invention is output to warn that the operating resources of the corresponding point searching unit 250 are short and to request the outside to take a countermeasure and any information in accordance with this object except the above-mentioned may be output to the display.

In the threshold adjustment process 2320, the buffer information 1950 is input from the image pair FIFO 240, a key image logarithm TNK and a normal image logarithm TNN are set according to the bulk of the buffer information 1950 BI, and an image type determining process 2330 is executed.

In the image type determining process 2330, the image setting information 2160 is input from the image setting DB 2110, if the current image is a key image, a key image image pair process 2350 is executed, and if the current image is a normal image, a normal image image pair process 2340 is executed.

In the key image image pair process 2350, the image setting information 2160 is input from the image setting DB 2110, the frame information 2180 is input from the frame information DB 2120, a normal image a photographed position of which exists in a fixed range of the current frame is selected as a candidate of a normal image image pair, and a key image image pair output process 2370 is executed.

In the key image image pair output process 2370, when the number of normal image image pair candidates is larger than the key image iamge logarithm TNK, normal image image pair candidates are selected by the number of the key image iamge logarithm TNK in closer order in positional information.

At this time, when plural images photographed in the same position exist, the closer images in time series are preceded.

Further, respective image IDs of the normal image image pair candidates and image IDs of the key images are output together to the image pair FIFO 240 as the image pair information 460.

In the normal image image pair process 2340, the image setting information 2160 is input from the image setting DB 2110, the frame information 2180 is input from the frame information DB 2120, a key image in a fixed range from the current image is selected as a key image image pair candidate, and a normal image image pair output process 2360 is executed.

In the normal image image pair output process 2360, when the number of key image image pair candidates is larger than the normal image iamge logarithm TNN, key image image pair candidates are selected by the number of the normal image iamge logarithm TNN in closer order in positional information.

At this time, if plural images photographed in the same position exist, closer images in time series are preceded.

Further, respective image IDs of the key image image pair candidates ad image IDs of the normal images are output to the image pair FIFO 240 together as the image pair information 460.

Next, an example of a key image logarithm setting method will be described.

In the threshold adjustment process 2320, the key image logarithm TNK is calculated in the following expression based upon a key image logarithmic coefficient ATNK, a key image logarithmic constant CTNK and the buffer information 1950 BI.

TNK=ATNK*BI+CTNK Equation 8

The expression for calculating the key image logarithm TNK in this embodiment has intention to reduce a load of the corresponding point searching process because the corresponding point searching process is not in time, residual buffer capacity of the image pair FIFO buffer decreases and when the buffer information 1950 BI has a small value, the key image logarithm TNK also has a small value.

Besides, the key image logarithmic constant CTNK means an image logarithm between a key image which is necessary at the minimum to keep the quality of a mosaic image and which is the current image and a normal image in the circumference of the current image.

Next, a normal image logarithm setting method will be described.

In the threshold adjustment process 2320, the normal image logarithm TNN is calculated in the following expression based upon a normal image logarithmic coefficient ATNN, a normal image logarithmic constant CTNN and the buffer information BI.

TNN=ATNN*BI+CTNN Equation 9

The expression for calculating the normal image logarithm TNN in this embodiment has intention to reduce a load of the corresponding point searching process because the corresponding point searching process is not in time, residual buffer capacity of the image pair FIFO buffer decreases and when the buffer information 1950 BI has a small value, the normal image logarithm TNN also has a small value.

Besides, the normal image logarithmic constant CTNN means an image logarithm between a normal image which is necessary at the minimum to keep the quality of a mosaic image and which is the current image and a key image in the circumference of the current image.

The above-mentioned expressions are examples and when the residual buffer capacity decreases, control that the number of normal image pairs and key image pairs to be processed is reduced has only to be made. Moreover, only either of the normal image logarithm or the key image logarithm may be also controlled.

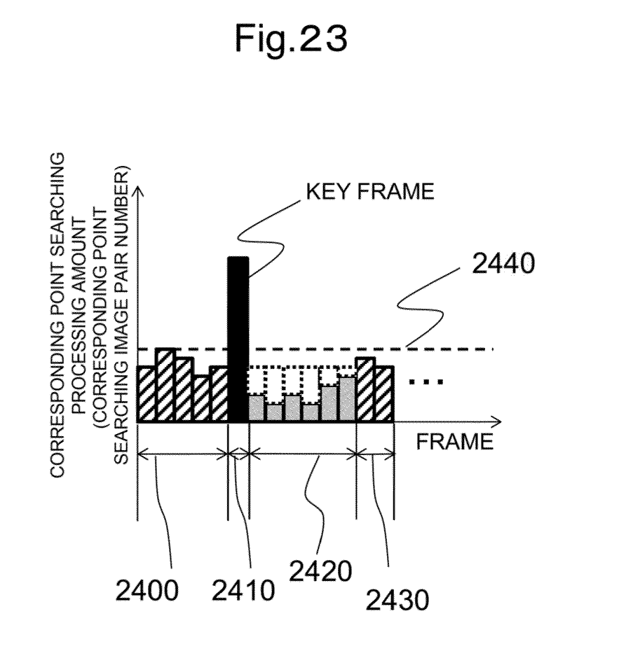

FIG. 23 is a graph showing the effect of adjusting a load of processing in the corresponding point searching process in this embodiment of the present invention.

An axis of ordinates shown in FIG. 23 shows the throughput of the corresponding point searching process and is a value proportional to the buffer information BI. An axis of abscissas shown in FIG. 23 shows the number of frames and the graph shown in FIG. 23 shows the fluctuation of the throughput of the corresponding point searching process every frame.

FIG. 23 shows a normal state 2400, a state 2410 in which a key image is added, a state 2420 in which operating resources are short and a normal state 2430 from the left side. In the normal state 2400, the throughput does not exceed an upper limit of an allocatable operation amount 2440. In the state in which the key image is added 2410, even if a load of the corresponding point searching process temporarily increases by key image setting, an image logarithm selected in the following normal image is dynamically limited by the image pair generation process in the embodiment of the invention. Accordingly, the increase of the throughput by key image setting is covered and the corresponding point searching process can be executed at an operation amount less than the upper limit of the allocatable operation amount.

In the first to third embodiments, when the number of image pairs output to the image pair FIFO 240 in the image pair generation process because of the key image setting and others increases, processing is not in time depending upon the throughput of resources because a load of the corresponding point searching unit 250 increases and the generation of a mosaic image at real time may be made impossible.

Even if the load of the corresponding point searching process temporarily increases, the mean of the load as the whole is adjusted to be fixed or less by reducing a corresponding point searching process of later images by adjusting the load of the corresponding point searching process in the embodiment of the present invention, and the execution of the generation of a mosaic image at real time is realized. In addition, when it can be judged that the adjustment of the load of the process is not in time by the setting of the units and limiting operating resources, the notice of warning and a countermeasure to a user is realized by outputting the buffer warning 2000 to the outside.

In this embodiment, the similar function to a function configured by software can be also realized by hardware such as a field programmable gate array (FPGA) and an application specific integrated circuit (ASIC). Such a mode is also included in a scope of the present invention.

The present invention is not limited to the above-mentioned embodiments and various variations are included. For example, a part of the configuration in the certain embodiment can be replaced with the configuration in the other embodiment and the configuration in the other embodiment can be added to the configuration in the certain embodiment. Further, as for a part of the configuration in each embodiment, the configuration in the other embodiment can be added, can be deleted or can be replaced.

What is claimed is:

1. An image generating method of taking a plurality of images consecutive over time by a camera, and generating a single image from the plurality of images, the image generating method comprising:
a storing step of making image taking condition data and image data correspond to each other to store for each of the plurality of images;
a key image setting step of selecting a plurality of representative images from the plurality of images;
an image pair selecting step of selecting an image having a prescribed relationship with the representative image as a relevant image for each of the representative images based on the image taking condition data, and storing the representative image and the relevant image having the prescribed relationship with the representative image as an image pair;
a corresponding points searching step of calculating corresponding points which are a set of the same points in the images for each of the image pairs; and
an image synthesizing step of synthesizing the plurality of images by using the corresponding points to generate the single image.

2. The image generating method according to claim 1, wherein the key image setting step processes the plurality of images in a time series order, and sets a current image to the representative image in a case where a number of frames from the representative image set at an immediate vicinity to the current image is a prescribed threshold.

3. The image generating method according to claim 1, wherein the key image setting step processes the plurality of images in a time series order, calculates a positional relationship between the representative image set to an immediate vicinity and a current image based on the image taking condition data, and sets the current image to the representative image in a case where positions of the both images are remote from each other by a prescribed threshold or more.

4. The image generating method according to claim 1, wherein the key image setting step and the corresponding point searching step process the plurality of images in a time series order, and the key image setting step sets the processed image as the representative image in a case where a number of the corresponding points fed back from the corresponding point searching step is equal to or less than a prescribed threshold.

5. An image generating apparatus comprising:
a camera for acquiring image data by taking an image of an object in a prescribed image taking range, configured such that when a plurality of image data pieces are acquired, an arbitrary one image data piece includes the same object as an object of another plurality of image data pieces;
a feature point sampling unit for sampling a feature point from the image data;
a feature database for making information of the feature point and the image data correspond to each other to store;
a sensor for acquiring sensor information relevant to at least one of a position, a speed, an acceleration, and an attitude of the camera when the camera acquires the image data;
an image pair selecting unit for selecting a plurality of representative images from the plurality of image data pieces, selecting a relevant image for each of the representative images based on the sensor information, and generating an image pair comprising a set of the representative image and the relevant image;
a corresponding point searching unit for making the feature points correspond to each other and generating corresponding point information in a case where the feature points included in the image data of the image pair are determined to pertain to the same object;
an image position adjusting unit for generating adjustment information of positions of the plurality of images based on the corresponding point information; and
an image synthesizing unit for generating a single image from the plurality of images based on the adjustment information.

6. The image generating apparatus according to claim 5,
wherein the camera is mounted on a moving body for moving the camera or a drive mechanism for changing an attitude of the camera, and
the sensor acquires at least one piece of information of a position, a speed, an acceleration, and an attitude of the moving body or the drive mechanism,

7. The image generating apparatus according to claim 5,
wherein the image data is image data photographed consecutively, and inputted to the image pair selecting unit in an order of photographing, and
the image pair selecting unit includes a key image setting unit for selecting a plurality of the representative images from the plurality of image data pieces such that the number of images between the representative images is not equal to or more than a prescribed threshold.

8. The image generating apparatus according to claim 5,
wherein the image data is image data photographed consecutively, and inputted to the image pair selecting unit in an order of photographing, and
the image pair selecting unit includes:
a sensor information database for making the image data and the sensor information correspond to each other to record; and
a key image setting unit for calculating a positional relationship between the image data based on the sensor information, and selecting the plurality of representative images from the plurality of image data such that a positional relationship between the representative images is not remote from each other by a prescribed threshold or more.

9. The image generating apparatus according to claim 8, further comprising:
a threshold adjusting unit for adjusting the threshold based on the sensor information.

10. The image generating apparatus according to claim 5, wherein at least one of a selecting condition of the representative image and a selecting condition of the relevant image in the image pair selecting unit can be controlled in accordance with an input from a control terminal.
